(19) United States
(12) Patent Application Publication
(10) Pub. No.: US 2010/0088376 A1
(43) Pub. Date: Apr. 8, 2010

(54) Obtaining content and adding same to document

(75) Inventors: Michael C. Kunz, Seattle, WA (US); Chad Steven Estes, Woodinville, WA (US); Ojiakonobi Udezue, Sammamish, WA (US); Michel Guittet, Redmond, WA (US); David Barlin, Seattle, WA (US); Robert M. Dolin, Seattle, WA (US); Gabriela Ferreres, Kirkland, WA (US); David W. Law, Seattle, WA (US); Wilhelmina Dietrich, Seattle, WA (US); Michael P. Mastrangelo, Seattle, WA (US); Emmanuel Jose Miranda-Steiner, Redmond, WA (US); Nathalie Sophia Collins, Sunnyvale, CA (US); Allison O'Mahony, Bellevue, WA (US); Aaron Getz, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/245,689

(22) Filed: Oct. 3, 2008

(51) Int. Cl. G06F 15/173

(52) U.S. Cl. 709/205

(57) ABSTRACT

Mechanisms to assist a user in obtaining content may be integrated with the tools that allow the user to author an e-mail message or any other type of document. For example, an e-mail composition system may offer various buttons that allow users to obtain certain types of content—e.g., movie times, restaurant menus, etc. When the user clicks the button, the requested type of content may be obtained, and the user may be offered the opportunity to insert the obtained content into the document that is being authored. The content that is obtained may follow a particular structure. For example, a system might be configured to respond to a request for movie-related content by returning a list of show-times and theaters for a particular movie.

### BACKGROUND

The process of composing content often involves some form of research and/or information retrieval. A person who is composing an e-mail message may want to include some information that is obtained through a search or through some other mechanism. For example, a person might compose an e-mail to a friend, proposing to meet at a movie. The e-mail might include a list of times and theaters where the movie is showing, and, perhaps, a map to the theater. This information is readily available through the Internet. Many search engines, when queried on the name of a first-run movie, will respond with a list of theaters and show-times in the inquirer's local area. The list of theaters may also provide addresses. Some search engines may offer to provide a map to the address. Or, a toolbar may recognize some of the text in the search results as an address, and may offer to link to a map. Thus, if the person wants to include a list of theaters, show-times, and a map, this information can readily be obtained through the Internet.

While the above information is available, the process of accessing the information is not particularly convenient. Typically, in order to access such information, the user opens a new browser window or tab, performs a search, and then copies-and-pastes the requested information into the e-mail. This process is cumbersome. Moreover, the search engine typically does not communicate with the e-mail program, and therefore is not able to make use of whatever context might exist, such as the context that could be derived from the message that is currently being composed.

Various user interface (UI) designs have attempted to integrate search capability into a browser window. For example, toolbars and search panes offer the ability to search for content without opening a new window or tab, and without having the current window or tab taken over by the search results. However, performing a search does not necessarily meet a user's goal, particularly if the user's goal is to find content to be included in an e-mail (or in another type of document). A search generally provides a list of documents (e.g., web pages) that contain a search term. This list might be adequate for a general research task, but the scope of content that the user is looking for often depends on what he or she intends to do with the content. The user might have different expectations depending on whether the search is being performed for the user's general knowledge, or to find content to be included in an e-mail message. Thus, the user may have to examine several results to find the content he or she wants, and then may have to copy-and-paste the content into the document that he or she is authoring. For example, if a user queries the name of a restaurant, he or she may have to examine several documents before finding the restaurant's menu and address. If the user wants to include a map to the restaurant, he or she may have to copy the address from one of the documents into the address box of a map service, and then copy-and-paste the map. While search engines, map services, and the like, have made much information readily available, these tools may be awkward to use as part of the process of authoring content.

### SUMMARY

Tools may be provided to integrate the act of obtaining content into the process of authoring a document. A user interface (UI) that facilitates the authoring of an e-mail message (or other type of document) may provide a place to compose content. The UI may also provide controls that allow the user to obtain additional content to be included in the document. For example, one element of the UI may be a composition window or box into which the user types arbitrary content (e.g., where the user might type the text of an e-mail message). Another element of the UI may be a list of categories in which content may be obtained—e.g., movie times, restaurants, telephone listings, etc. Each category may be represented by a navigation and/or actionable element (such as a button, link, right-click action, etc.), so that if the user clicks the button or link (or activates some other type of element), the user is provided with content appropriate for the category. The content may be provided in a way that allows the user to include the content in a document. For example, if the user clicks on the restaurant category, the user might be shown a list of restaurants in the user's local area, along with the restaurants' menus, and maps of where restaurants are located. By clicking on items in the preview area, these items might be added to the composition window or box. In this way, the process of finding content is integrated with the process of including the content in the document.

The content that the tool provides may be curated in some way. For example, choices may be made about which database will provide restaurant information, which database will provide movie information, etc. Thus, when a user clicks on a category such as “restaurant,” the content obtained about restaurants is retrieved from the chosen database. The choice of a particular source of content might be made as part of a business arrangement. For example, suppose that the UI that allows a user to obtain content is offered as part of a particular web-mail system. The provider of the web-mail system might enter into an arrangement with the provider of a restaurant database to use that database as a source of restaurant information. Such an arrangement might provide a way of monetizing the web-mail system, although an arrangement could be entered into with or without monetary terms. Similar arrangements could be made with other types of content providers—e.g., a particular DVD-by-mail service could be chosen as the provider of a movie database.

Additionally, the content to be obtained may be focused on the type of content that one might seek out to include in a document. For example, a person who is composing an e-mail to a friend about a first-run movie is more likely to be interested in finding where the movie is playing than in finding a scholarly analysis of the movie. A search engine would likely return the location of a theater and anything that has ever been written about the movie. A tool that is focused on providing content for e-mail, however, could focus on obtaining movie locations while omitting information that is less likely to be the kind of content someone would want to include in an e-mail message.

Moreover, when a user requests content to insert in a document, the content that is obtained could be chosen based on the content of the document. For example, a person might be composing an e-mail message containing the text, “Let's see the new Batman movie.” If that person requests content in the “movie” category, the text of the e-mail could be analyzed to determine that the person is interested not in movies generally, but specifically in a Batman movie. The content that is obtained could then be tailored the Batman movie—e.g., the content could include times at which the Batman movie is showing, a list of theater that are showing that movie, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example user interface that may be used to author a document.

FIG. 2 is a block diagram of information that may be displayed about content that has been obtained.

FIG. 3 is a flow diagram of an example process in which content may be obtained and inserted into a document.

FIG. 4 is a flow diagram of an example process in which a search is used to obtain content.

FIG. 5 is a block diagram of an example system that may facilitate the composition of a document and the obtaining of content for the document.

FIG. 6 is a flow diagram of example actions that may be performed in order to allow a user to author a document and to obtain content for a document.

FIG. 7 is a block diagram of example components that may be used in connection with implementations of the subject matter described herein.

### DETAILED DESCRIPTION

When people compose documents, they often include some type of existing content in the document. For example, a person may create an e-mail message that contains a map, a restaurant menu, an entry from a telephone directory, etc. The content may be obtained through various tools. For example, web content may be obtained using a search engine. A map may be obtained from a map web site (or from the map service of a search or portal web site). A person obtains the content and then transfers the content to the document—e.g., by a copying-and-pasting the content. (A document may include any type of content. An e-mail is one example of a document, but a document could also be a word-processing document, a spreadsheet, a graphic, etc.)

Existing mechanisms reflect a lack of integration between the process of composing a document and the process of finding content to add to the document. If a user is composing an e-mail message and wants to find content to insert, the user typically opens a browser window or tab, navigates to a search engine, forms a query, examines query results, and copies-and-pastes appropriate content from one of the query results into the document. Many of the actions involved in this process are cumbersome. For example, if the user is composing an e-mail message about a particular movie and wants to find show-times for the movie, the user typically opens a browser window and types the movie name into a search engine. The search engine may respond with show-times at a local theater, and the user may then copy the show-times into the e-mail message. If the user wants to include a map of the theater's location in the message, the user typically visits a map web site, obtains the map, and copies it into the message.

However, if the process of searching for movie-related information is integrated into the software that is used to compose e-mail messages, then adding information about movies could be simplified. Information to drive the search might be extracted from a partially-composed e-mail. For example, the e-mail message might name a particular movie. If the UI through which e-mail messages are composed offers a feature to search for movies, that feature could extract the name of the movie from the partially-composed e-mail message, and a search could be performed for information about that movie.

But even if the name of the movie cannot be extracted from the e-mail message, integrating the process of obtaining content with the process of composing a document allows certain other enhancements to the user experience. For example, if the UI for composing an e-mail provides a button (or other actionable element) to get movie information, the type of content that is retrieved can be focused on the type of content that a user would likely want to include in an e-mail message—e.g., theaters, show-times, and a map of the theaters' locations. This information is more focused that what would be provided by a normal search engine, since the search engine might return dozens or hundreds of documents that happen to contain the name of the movie. This level of focus is possible because—by integrating a content-obtaining feature into a system that is used to compose a document—the content-obtaining feature may be tailored to return the type of content that one would likely want to include in a particular type of document. Moreover, a streamlined process can be offered to add the content to the e-mail message or other document. For example, after the content has been obtained, previews of the content could be shown, and the user might add the content by clicking on the preview. When a user can add content to a document in this way, the normal copy-and-paste procedure is bypassed.

The subject matter herein provides various ways to integrate the process of obtaining content with the process of composing a document. For example, a user interface for a web-mail system may provide an area into which the user types text, and may also provide a set of actionable elements (e.g., buttons, links, right-click options, etc.) to obtain various types of content—e.g., movies, restaurants, telephone numbers, etc. When the user clicks one of the buttons, content of the appropriate type is obtained—e.g., movie times, restaurant menus, telephone listings, etc. The content that is obtained may be tailored to reflect the type of content that a user would likely want to include in an e-mail message (or whatever type of document is being authored). Thus, if the user requests restaurant content, a system might return the restaurant's menu and the address of the restaurant, on the assumption that the user wants content that would be helpful in making a decision about where to eat dinner. Other information—such as the name of the restaurant's chef or the nutrition information for a particular entrée—might also be available, but the system might omit this type of content as being less likely to be the kind of information that a person is looking for when composing an e-mail message.

The particular choice of buttons (or other actionable elements) to offer, or the content to be returned in response to clicking a particular button (or in response to activating some other actionable element, might be based on some sort of business relationship. For example, a web-mail service might enter into a co-branding relationship with another company, in which the web-mail service agrees to offer a button with that company's brand or to use that company's database as a source of content. Thus, the restaurant button could be named “Zagat”, and/or could return information on restaurants from Zagat's database. Moreover, tools could be provided to allow third parties to add content-obtaining functionality to their applications. For example, Company A might offer a content-obtaining service, and might then offer a toolkit that allows company B to offer company A's content-obtaining tool on its web site. Thus, if company B operates a web-mail service or an on-line word processor, company B could use the toolkit to add company A's content-obtaining functionality to company B's web site. The foregoing are some example scenarios of how content-obtaining tools could be integrated into a document-composing system, but other integration scenarios are also possible.

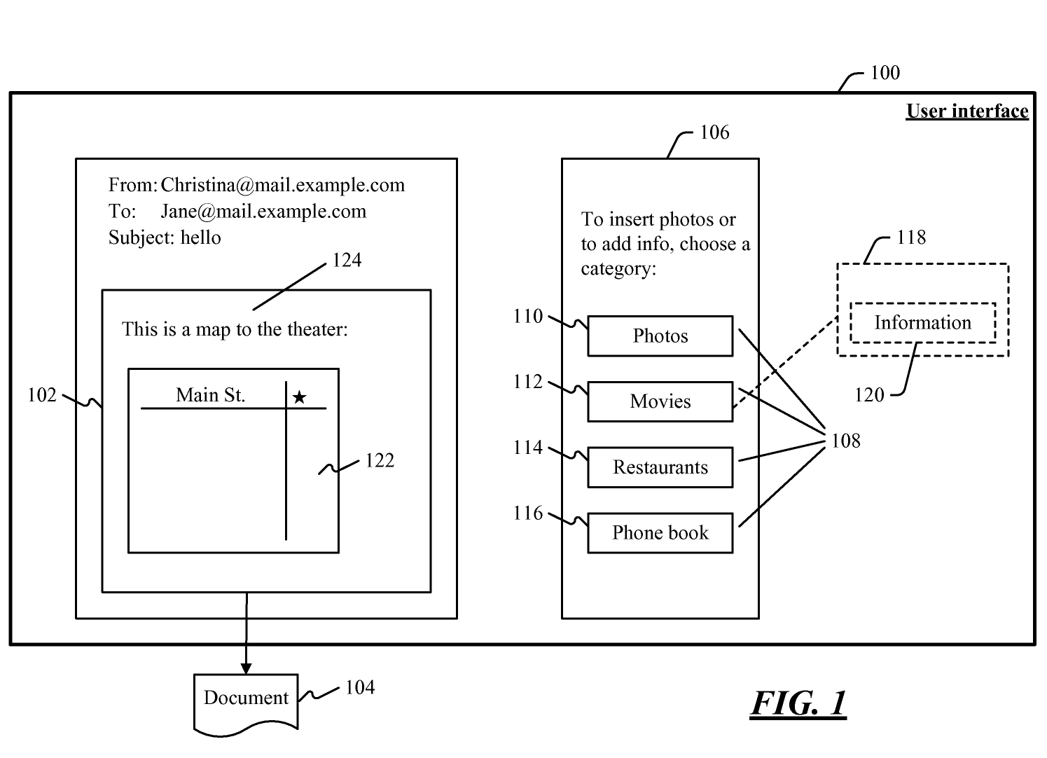

Turning now to the drawings, FIG. 1 shows an example user interface 100 that may be used to author a document. User interface 100 could take various forms. For example, user interface 100 could be the interface for a web-mail application, in which case user interface 100 might be implemented through browser-related technologies (e.g., Hypertext Markup Language (HTML), Java, etc.). However, user interface 100 could also be for a non-web application, such as a standalone desktop application. In such an example, user interface 100 might be displayed within a window provided by an operating system.

User interface 100 may include a first element 102 which is used to compose document 104. In the example of FIG. 1, element 102 is a space into which a user may type text, and document 104 is an e-mail message. However, document 104 could be a word processing document, a spreadsheet, or any other type of document. Element 102 may be a space into which content for document 104 could be typed. For example, when a user types characters with a keyboard, the characters might appear within element 102, as they would, for example, in the case of an e-mail composition window.

User interface 100 may also include a second element 106, which may be used to obtain content and/or to insert the obtained content into document 104. Element 106 may include one or more controls 108 that allow the user to activate a process of obtaining and/or inserting various types of content. In the example of FIG. 1, controls 108 are shown as buttons, which a user might activate by pointing to the button with a mouse or other pointing device, and clicking on the button.

Each of controls 108 may offer the opportunity to obtain a different kind of content. FIG. 1 shows examples of various categories of content that could be offered, although any categories could be offered. In the example of FIG. 1, there is a “photos” button 110, a “movies” button 112, a “restaurant” button 114, and a “phone book” button 116. Each of these buttons may represent a different kind of content that could be obtained. Clicking on the button may set in motion a process of obtaining the type of content associated with the button. Thus, clicking button 110 might obtain photographs, clicking button 112 might obtain show-times and locations for movies, and so on. Any process of obtaining content could be used, and the process could obtain content from any source. Searching an index of web pages is one example of a process of obtaining content (in which case the content source is the web). However, other processes could be used. Other examples of processes for obtaining content, and other examples of sources from which content may be obtained, are described below.

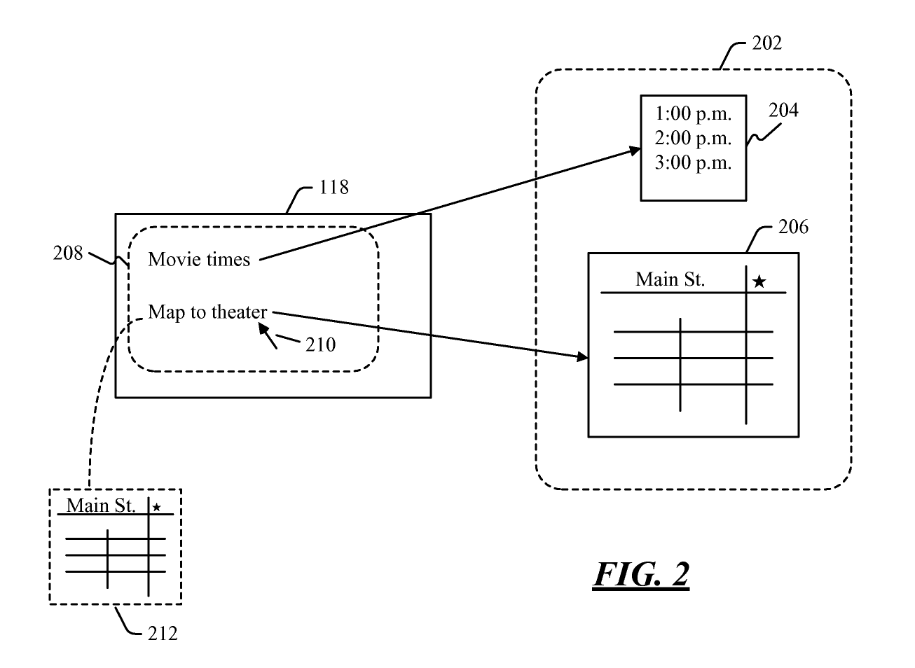

Regardless of the process that is used to obtain content, the result of clicking a particular button may be to cause such content to be obtained, and to show a representation of that content in some manner. FIG. 1 shows an example in which a user clicks “movies” button 112. Behind the scenes, content may be obtained that relates to movies. (The content could relate to movies in general, or it could relate to a specific movie. For example, a user might type the name of a specific movie into a search box. Or, if a partially-composed document that is being composed within element 102 contains the name of a movie, that name could be used.) Regardless of the content that has been obtained, the process may return some indication 118 of the obtained content. In the example of FIG. 1, indication 118 is shown as a box containing information 120. Examples of the type of information 120 that might be contained in the box are shown in FIG. 2, and are discussed below.

Once a user has seen the indication 118 of the particular content that has been obtained, the user may choose to perform various actions. One such action is to preview the content—e.g., the user might be able to see a thumbnail of a graphic, or an excerpt of textual content. Another example of an action that a user might choose to take is to insert the content into document 104. For example, suppose that indication 118 indicates that the content that has been obtained includes show-times for a particular movie and a map to the theater. The user might choose to insert map 122 document 104. Thus, in this example, document 104 (which is being composed within user interface element 102) comprises content 124 (which are words that may have been entered with a keyboard), and also comprises map 122. Map 122 is an example of an item of content that may be obtained through user interface element 106, and that may be inserted into a document.

As noted above, the indication 118 of obtained content may provide various types of information. FIG. 2 shows examples of such information. It is noted that, while FIG. 2 shows an example of an indication 118, that indication could take any form. For example, with respect to some underlying set of obtained content, indication 118 could contain the full set of obtained content or some selection of that content. Moreover, indication 118 could contain the actual content that was obtained, or some condensed version or representation of that content.

Returning to the example of FIG. 2, when a user clicked the “movies” button 112 (shown in FIG. 1), content 202 was obtained. Content 202 includes various items 204 and 206. Item 204 is a list of events (e.g., the show-times of movies), and item 206 is a map to the locations where the events may occur (e.g., a movie theater, with the star on the map indicating the location of the theater). Indication 118 could show the actual content that was obtained. Or, indication 118 could show some representation of the content other than the content itself, as depicted in the example of FIG. 2. Thus, in the example of FIG. 2, indication 118 shows a list 208, which describes the content 202 that has been obtained.

A user may be given the opportunity to preview the content. For example, a user might use a pointing device to move a cursor 210 over one of the items on the list. A “hover” behavior could be implemented, whereby a preview 212 of a particular content item is displayed when the cursor controlled by a pointing device is hovered over an item on the list. (One example set of behaviors is to preview an item when the cursor is hovered over an item on the list, and to insert the underlying content item when the user clicks the item on the list. However, these behaviors are merely examples, and other behaviors could be implemented.) In the example of FIG. 2, cursor 210 is hovered over the “map to theater” item on a list, and thus the preview 212 that is displayed is a small version of the map in item 206. However, a preview could take any form. It is noted that the relationship between the preview and the content that is actually inserted into a document is arbitrary. For example, the preview could be the same as the content to be inserted, or could be a subset or superset of the content to be inserted, or could be representative of the content to be inserted (but different from that content). As one example, for movie-related content, the preview might show a movie's name, rating, and review, while the content to be inserted might show the movie name and showtimes. As another example, the preview might show the movie name and/or times, while the content that is inserted might include a clip of the movie, related links, etc.

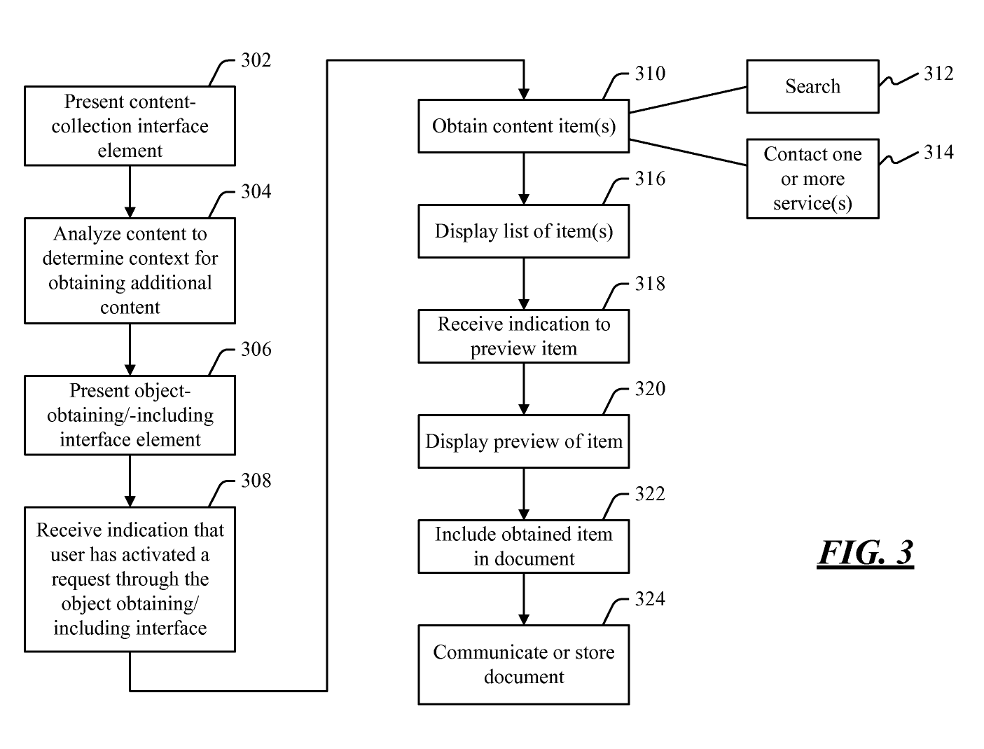

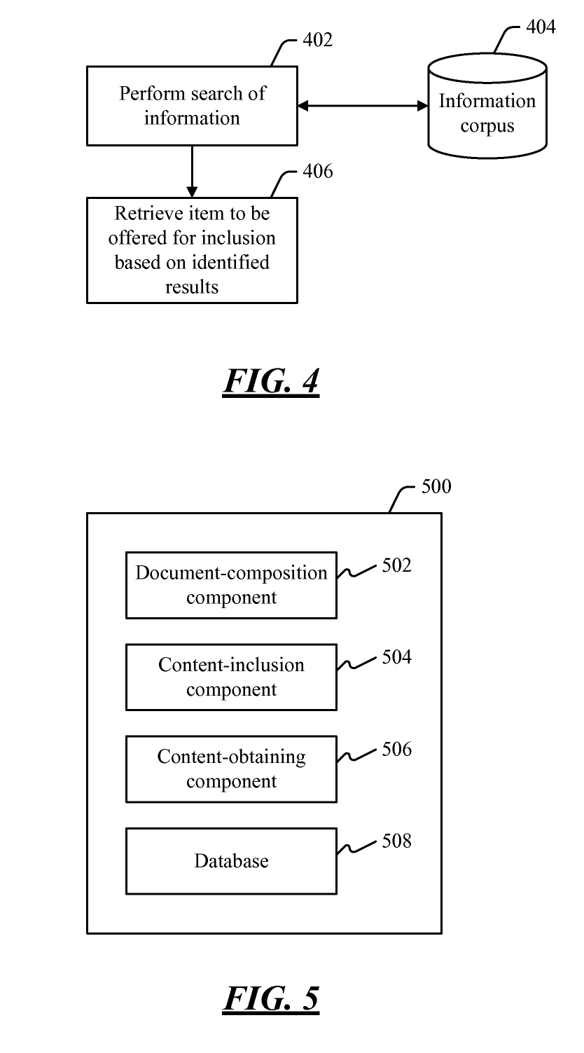

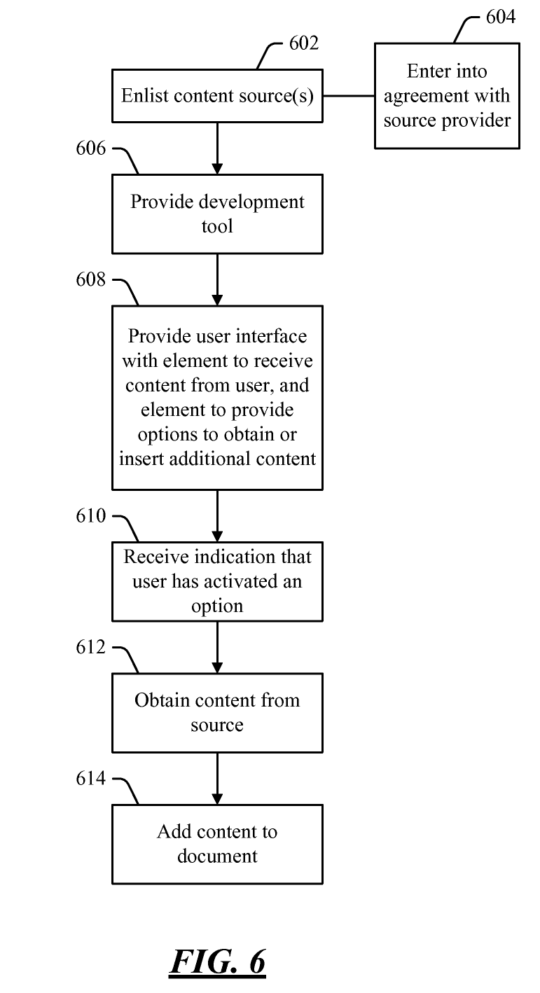

FIG. 3 shows, in the form of a flowchart, an example process in which content may be obtained and inserted into a document. Before turning to a description of FIG. 3, it is noted that the flow diagrams of FIG. 3 (as well as the flow diagrams shown in FIGS. 4 and 6) show examples in which stages of a process are carried out in a particular order, as indicated by the lines connecting the blocks, but the various stages shown in these diagrams may be performed in any order, or in any combination or sub-combination.

Turning now to FIG. 3, at 302, a content-collection interface element may be presented. For example, FIG. 1, shows an user interface element 102 as a box into which textual content may be typed. User interface element 102 is thus an example of a content-collection interface element. However, a content-collection interface element could take any form.

At 304, any content that has been entered into the content collection interface element may be analyzed to determine a context for obtaining additional content. For example, if a document that is being authored is an e-mail message, and the message contains the name of a movie, then it might be inferred that the user who is composing the message would be interested in inserting movie related content into the message. This information could be gleaned by analyzing the text that has already been typed into the e-mail message (even if the e-mail message is only partially-complete). Thus, this analysis might be used as an impetus to display the “movies” button 112 (shown in FIG. 1). (For example, the particular choice of buttons displayed might be based on the context—e.g., the “movies” button might be displayed if the message being composed mentions the name of a movie, or the “restaurant” button might be displayed if the message mentions food, etc.) Additionally, the analysis might yield a content selection or filtering criterion that could be used in searching for, or retrieving, information. For example, the name of a particular movie in the e-mail message might be used as a query term in order to search for movie-related information.

At 306, an object-obtaining/object-including interface element may be presented. For example, user interface element 106 (shown in FIG. 1) is an example of an object-obtaining/object-including interface, in the sense that it allows the user to set in motion the processes of obtaining content and/or including the obtained content in a document.

At 308, an indication may be received that a user has activated a request for content through the object-obtaining/object-including interface. For example, the user might click one of buttons 110-116 (shown in FIG. 1). If a user interface takes the form of an HTML web page, then each button might be a link, and activating the link might generate a Hypertext Transfer Protocol (HTTP) request. Such an HTTP request is an example of an indication that could be received at 308. However, the request could be made and/or received in any manner.

At 310, a content item may be obtained in response to the request. For example, FIG. 2 shows a collection of movie-related content 202 which may have been obtained in response to a request. Content 202 contains items 204 and 206. These are examples of items of content that may be obtained at 310. While FIG. 2 shows an example in which the content obtained includes two items, in general any number of content items (one, or more than one) could be obtained at 310.

There are various processes that could be performed to obtain content item(s) at 310. One such example process is a search 312. For example, obtaining information about a movie or restaurant could be performed by using the name of a movie or restaurant as a query to a search engine. When search 312 is performed, the process of obtaining information may proceed as shown in FIG. 4. In such a process, a search may be performed (at 402) over information corpus 404 in order to select some of the information in the corpus. The information corpus could be an index of publicly-accessible web pages, a “desktop search” index, or any other type of information corpus. The information corpus could be a single source, or could be a plurality of different sources (such as one or more data service and/or one or more repositories of data, or a combination thereof). (In some cases, canvassing several sources for content may add value to the results, in the sense that a system could aggregate content from different sources or could select content from among different sources. However, the subject matter herein applies to systems that obtain content from one source or more than one source.) Searching of the information corpus may generate some results, and an item of information may be retrieved (at 406) based on the results. For example, the document with the highest relevance score in the search results could be retrieved. The content of that document could be one of the content items that is obtained at 310 and that may be offered for inclusion in a document that is being composed.

Returning now to FIG. 3, another example process of obtaining content involves contacting one or more services (block 314). For example, as noted above, a request to obtain content about a movie or restaurant might involve obtaining a map of a particular locale. Maps are typically not obtained by search, but rather are generated by map services. Thus, the process of obtaining content does not necessarily involve searching a corpus of existing content, but rather may involve generating content.

Search 312, and contacting a service (block 314), are examples of processes of obtaining content. However, any process may be used at 310 to obtain a content item.

At 316, a list of one or more content items may be displayed. For example,

FIG. 2 shows a list 208 that identifies various items of content that were found by a content-obtaining process. List 208 is an example of a list that could be displayed at 316, although such a list could take any form.

At 318, an indication of a request to preview an item may be received. As noted above in connection with FIG. 2, a user might make such a request by hovering a pointing device over a particular item on a list. However, the request to preview the item could take any form. At 320, a preview of the item may be displayed. With reference once again to the example of FIG. 2, preview 212 is an example of a preview that could be displayed. However, the preview could take any form.

At 322, an obtained item may be included in a document. For example, a user could click on a particular item on the list that was displayed at 316. This clicking could be an indication to include a particular content item within a document that is being composed.

Once a document has been composed—by entering content through a keyboard, by obtaining/including content by the processes described above, or by some other mechanism—the document may be communicated or stored in some manner (at 324). For example, an e-mail message (or any other type of document) might be sent over a network, or the document may be stored on a disk. Any use of an authored document could be made.

FIG. 5 shows an example system 500 that may be used to implement some or all of the subject matter described herein. System 500 may be used to carry out the process of FIG. 3, but could be used to carry out any process. Conversely, the process of FIG. 3 could be carried out using the components of system 500, but could be carried out with any components.

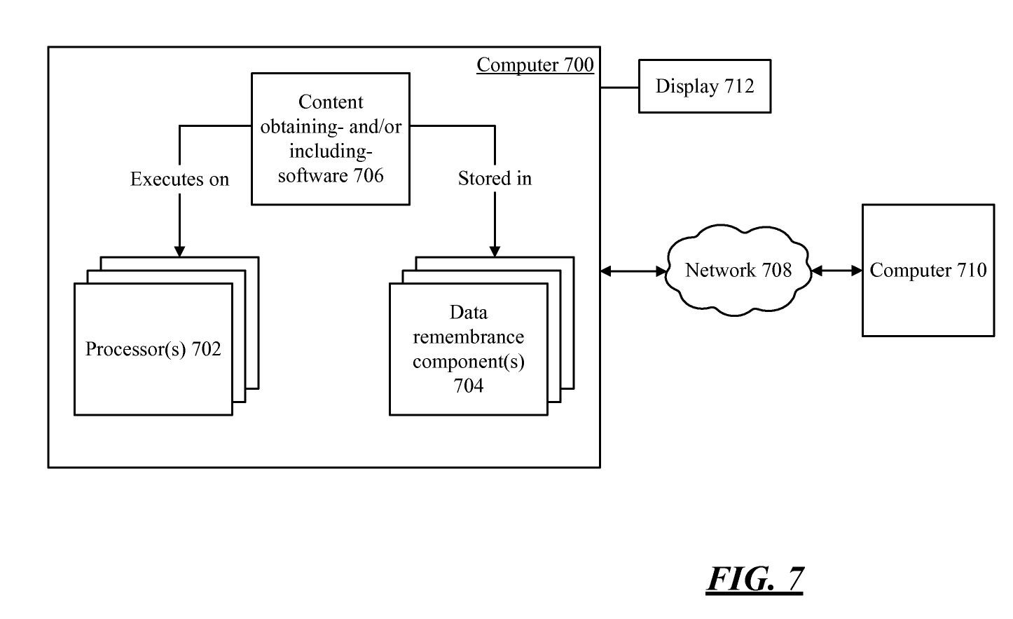

System 500 may include document-composition component 502, content-inclusion component 504, content-obtaining component 506, and/or database 508. These elements may be implemented in the form of code and/or data that is stored in a data remembrance component (discussed below in connection with FIG. 7), and/or that executes on a processor (also discussed below in connection with FIG. 7). As another example, the elements of system 500 could be implemented as hardware. However, the elements shown in FIG. 5 could be implemented in any manner.

Document-composition component 502 may receive content to be included in a document. For example, document-composition component 502 may generate and/or provide user interface element 102 (shown in FIG. 1), which collects typed content for a document.

Content-inclusion component 504 may assist a user in obtaining content to be included in a document. For example, content-inclusion component 504 may provide user interface element 106 (shown in FIG. 1), which may offer to obtain content to be included in the document. Content-inclusion component 504 may display various controls that are activatable by a user (e.g., the buttons shown in FIG. 1).

Content-obtaining component 506 may obtain content when requested by a user. For example, when a user activates a button (or some other type of control), content-inclusion component 504 may receive an indication that the control has been activated, and may request that content-obtaining component 506 take action to obtain the content. For example, content-obtaining component 506 could be a search engine, a map-generation service, or some other type of component that retrieves or creates content (or that causes such content to be retrieved or obtained).

Database 508 may be a store of content that could be obtained by content-obtaining component 506. For example, database 508 may store an index of web pages, a list of movies, a collection of restaurant reviews, etc. Database 508 is shown in FIG. 5 as being within system 500, but it could also be external to system 500.

FIG. 6 shows a set of example actions that may be performed in order to allow a user to author a document, and to obtain content for that document, as part of an integrated UI.

When tools to obtain content are integrated into an authoring interface, the tools may provide content from various sources. Thus, at 602, these sources may be enlisted. Enlisting the sources may involve choosing some public source of information (e.g., a particular search engine, a particular map service, etc.) However, some sources may involve more complex business agreements. As previously described, user convenience is one reason to integrate tools for obtaining content into a document-authoring interface. However, another possible reason to integrate the tools is to guide the choice of content through appropriate business agreements. For example, the operator of a web-mail service might offer content-obtaining tools on its e-mail composition screen. In order to monetize the web-mail system (or for some other reason), the operator of the service might enter into agreements (block 604) with the providers of various content sources. These agreements might call for a content-obtaining tool to promote content from a particular source, in exchange for money. For example, there could be an agreement with Zagat to provide restaurant information, with Netflix to provide movie information, etc. The providers of such information might pay to have the content-obtaining tools steer users to their content (or, alternatively, they might charge for the use of their content).

An additional type of business relationship that could be formed is for the entity that provides content-obtaining functionality to allow that functionality to be used with another entity's application. To facilitate such use, the entity that implements the content-obtaining functionality could provide a development tool to be used by other parties (at 606). For example, with reference to user interface element 106 of FIG. 1 (which may help a user to obtain content and to insert the content into a document), a development tool could be provided that allows that element to be added to an arbitrary web site. Thus, the operator of a web-mail service, an on-line word processing system, or any other type of system could use that development tool to add content-obtaining functionality to its web site.

At 608, an interface (e.g., user interface 100, shown in FIG. 1) may be provided to a user. Providing an interface to a user might involve delivering HTML content to be displayed on the user's web browser, or displaying content in a window provided by an operating system on the user's computer. The interface may have an element to receive content from the user (e.g., user interface element 102, shown in FIG. 1, which receives content entered with a keyboard). The interface may also have an element (e.g., user interface element 106, shown in FIG. 1) that provides options to obtain and/or to insert additional content from the sources that were enlisted at 602. It is noted that a particular source could be one of the options, or could simply be a source of content. For example, Zagat might provide restaurant information. Information from Zagat might be provided in response to clicking a “restaurant” button. However, there could be a “Zagat” button that returns such information.

At 610, an indication may be received that a user has activated one of the options to obtain content. As described above, the various options could be shown as buttons, each of which may generate an HTTP request when clicked. The receipt of such an HTTP request is an example of an indication that a user has activated a particular option. However, user interaction could be made in any form, in order to accommodate various different usage models. For example, network technologies other than HTTP could be used. Moreover, the user interaction (and the software with which the user is interacting) could be contained within a local machine rather than being distributed across machines in a network, in which case mechanisms could be used that support a user's interaction with a local application.

At 612, content may be obtained from a source that corresponds to one of the options. For example, if the user activates a restaurant option, then content from Zagat concerning restaurants might be obtained. The option might be named after the source (e.g., there could be an option to “search Zagat's database”), or an option with a more generic-sounding name (e.g., “restaurants”) might obtain content from one or more sources (e.g., Zagat) based on the fact that the user is looking for restaurant information.

After one or more items of content are obtained, one or more of these items may be added to a document (at 614). As described above, a user might click on an item to indicate that the item is to be added to the document. For example, FIG. 1 shows an example in which map 122 was obtained as content, and was then added to a document.

FIG. 7 shows an example environment in which aspects of the subject matter described herein may be deployed.

Computer 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is content obtaining- and/or including-software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as software having instructions to perform one or more acts of a method, where the instructions are stored on one or more computer-readable storage media. The instructions to perform the acts could be stored on one medium, or could be spread out across plural media, so that the instructions might appear collectively on the one or more computer-readable storage media, regardless of whether all of the instructions happen to be on the same medium.

In one example environment, computer 700 may be communicatively connected to one or more other devices through network 708. Computer 710, which may be similar in structure to computer 700, is an example of a device that can be connected to computer 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to perform a method of facilitating composition of a document, the method comprising:
presenting a first user interface element that receives, from a user, first content to be included in the document;
presenting a second user interface element that offers to obtain second content;
obtaining said second content in response to said user's activating of a control in said second user interface element;
including an item of said second content in the document; and
communicating the document over a network or storing the document.

2. The one or more computer-readable storage media of claim 1, wherein said second user interface element indicates a category of content, and wherein said obtaining of said second content comprises:
performing a search of a corpus of information to obtain results that identify items that are in said category; and
retrieving said item based on said item having been identified by said results.

3. The one or more computer-readable storage media of claim 1, wherein said obtaining of said second content comprises:
contacting a service that generates said item in response to said user's activating of said control.

4. The one or more computer-readable storage media of claim 1, wherein the method further comprises:
after obtaining said second content, displaying a preview of said item prior to said including.

5. The one or more computer-readable storage media of claim 4, wherein the method further comprises:
displaying a list of a plurality of items, said item having an entry in said list; and
receiving an indication that said user's pointing device is hovering over said item's entry in said list;
wherein said preview is displayed in response to said indication.

6. The one or more computer-readable storage media of claim 1, wherein said second user interface element lists a plurality of different categories.

7. The one or more computer-readable storage media of claim 1, wherein the method further comprises:
analyzing said first content to determine content selection criteria;
wherein said obtaining of said second content is based on said content selection criteria.

8. A system that includes an content item in a document, the system comprising:
a processor;
a document-composition component that executes on said processor, said document-composition component receiving first content to be included in the document;
a content-inclusion component that provides a user interface element that offers to obtain second content to be included in the document, said user interface element including an activatable control; and
a content-obtaining component that obtains said second content in response to a user's activating of said activatable control.

9. The system of claim 8, further comprising:
a database from which said content-obtaining component obtains said second content.

10. The system of claim 8, wherein the system is operated by a first entity, and wherein said content-obtaining component obtains said second content from a second entity, said first entity having entered an agreement to promote content of said second entity.

11. The system of claim 8, wherein said content-obtaining component obtains said second content by aggregating, or selecting from among, data obtained from a plurality of sources.

12. The system of claim 8, wherein said second content comprises an indication of an event and a map to a location at which said event is to occur, and wherein said content-inclusion component offers said user an option to include a description of said event, said map, or both said description of said event and said map.

13. The system of claim 8, wherein said content-inclusion component provides a preview of an item of said second content in response to a request from said user.

14. The system of claim 8, wherein said content-inclusion component provides said user with a selection of a plurality of categories of content.

15. The system of claim 8, wherein said content-inclusion component analyzes said first content to determine categories of content to offer to said user or a filtering criterion for a search that is used to obtain said second content.

16. A method of providing content to be included in a document, the method comprising:
enlisting a plurality of sources of content;
providing a user interface that comprises (a) a first element that receives first content to be included in the document, and (b) a second element that provides a plurality of options to add second content to the document, said options being based on said sources of content;
receiving an indication that a user has activated one of said options to obtain an item of said second content to include in the document;
obtaining said second content from one of said sources which corresponds to said one of said options; and
adding said item of said second content to said document.

17. The method of claim 16, further comprising:
entering into an agreement with a first entity that provides said one of said sources, wherein the agreement calls for a second entity, which performs the method, to promote said one of said sources; and
based on said agreement, using said one of said sources as a source of said second content.

18. The method of claim 16, further comprising:
entering into an agreement with a first entity that provides said one of said sources, wherein the agreement calls for a second entity, which performs the method, to promote said one of said sources; and
based on said agreement, offering said one of said sources as one of said options.

19. The method of claim 16, further comprising:
entering into an agreement with an entity that provides said one of said sources, wherein the agreement calls for said one of said sources to be promoted in exchange for money.

20. The method of claim 16, further comprising:
providing a development tool that allows an entity to include said entity's content as one of said options, or as one of said sources of said content.
